(19) United States
(12) Patent Application Publication
(10) Pub. No.: US 2013/0062430 A1
(43) Pub. Date: Mar. 14, 2013

(54) HEATABLE SPRAYING SYSTEM

(71) Applicant: J. Wagner GmbH, Markdorf (DE)

(72) Inventors: Niko ZWERGER, Friedrichshafen (DE); Jens ULBRICH, Friedrichshafen (DE); Thomas JELTSCH, Friedrichshafen (DE); Alfred GOERING, Salem (DE)

(73) Assignee: J. WAGNER GMBH, Markdorf (DE)

(21) Appl. No.: 13/621,438

(22) Filed: Sep. 17, 2012

Related U.S. Application Data
(63) Continuation of application No. PCT/EP2011/001441, filed on Mar. 23, 2011.

(30) Foreign Application Priority Data
Mar. 23, 2010 (DE) 10 2010 012 538.5

(51) Int. Cl. B05B 7/16; F24H 9/00

(52) U.S. Cl. 239/135; 392/441

(57) ABSTRACT

The invention relates to a portable paint spraying system, comprising a base station with a blower, paint spraying means, in particular a paint spray gun, at least one tube for connecting the base station and the paint spraying means, at least one paint container for receiving a quantity of paint, and a device for transmitting power to the paint container, wherein the quantity of paint in the paint container is heated by the transmitted power. In this case, the device for transmitting power is arranged in the base station.

### CROSS REFERENCE TO RELATED APPLICATIONS

This application is a continuation of International Application No. PCT/EP2011/001441 filed Mar. 23, 2011, which designated the United States, and claims the benefit under 35 USC §119(a)-(d) of German Application No. 10 2010 012 538.5 filed Mar. 23, 2010, the entireties of which are incorporated herein by reference.

### FIELD OF THE INVENTION

The invention relates to a portable paint spraying system and to a method for processing quantities of paint or coating materials or varnishes to be sprayed.

### BACKGROUND OF THE INVENTION

The processing of quantities of paint by spraying technology is well known from the prior art. Due to the legal requirement imposed on paint manufacturers to produce paints having as few solvents as possible, or even to completely omit certain types of solvents, the problem arises both for the paint industry and for the paint-processing industry that quantities of paint having a lower solvent content or having alternative solvents, for example, paints on the basis of water, have to be processed, wherein the surface which is to be produced and is intended to be obtained with the paint, as before, must not permit any step back in terms of processing quality.

One possibility of improving the application of paint to a surface and of achieving an increased surface coating quality without appropriate solvents, which frequently are highly volatile and also are irritating or even poisonous, additionally having to be admixed with the paint, consists in reducing the viscosity of the quantity of paint to be processed by the latter, for example, being heated and being applied in a heated state onto the surface.

The prior art, for example U.S. Pat. No. 2,148,986, discloses paint spray guns with heating devices, in which a conventional paint spray gun is placed together with the paint container thereof onto a heating plate and the quantity of paint which is located in the paint container is thereby heated.

However, a heating plate which is therefore used as heating means for the quantity of paint to be processed does not constitute a particularly convenient solution for workmen processing the paint, since a further apparatus for processing a quantity of paint is required.

### SUMMARY OF THE INVENTION

It is therefore the object of the invention to provide the possibility of processing heated quantities of paint without inconvenient additional apparatuses having to be transported and handled.

The invention relates to a portable paint spraying system which comprises a base station with a blower, paint spraying means, in particular a paint spray gun, at least one tube for connecting the base station and the paint spraying means, and at least one paint container for receiving a quantity of paint. Furthermore, the portable paint spraying system according to the invention comprises a device for transmitting power to the paint container, wherein the quantity of paint in the paint container is heated by said transmitted power. According to the invention, the device for transmitting power is arranged in the base station and partially in the paint container of the portable paint spraying system according to the invention.

Paint spraying systems, in particular those which make use of HVLP technology, generally comprise a blower which is used to provide the required conveying air for conveying a quantity of paint out of a spray nozzle. Said blower is arranged in an apparatus part which, in the present case, is referred to as the base station, since it is not absolutely necessary to arrange the blower directly on the paint spraying means, for example a paint spray gun. By integration of a device for transmitting energy, with which a quantity of paint in a paint container is heated, in the apparatus body of the base station, a compact and uniform apparatus version of a portable paint spraying system is provided without the paint spraying means which are to be handled and are constantly moved by the workmen having to be changed and without said paint spraying means, for example, increasing in weight because of the device for transmitting power.

In a development of the portable paint spraying system according to the invention, a stirrer is additionally provided, wherein the stirrer is submerged into the quantity of paint at least during the transmission of power to the paint container and therefore during the heating of the quantity of paint, and, in the process, the quantity of paint is moved by the stirrer.

This provides uniform heating of the quantity of paint and any scorching or local overheating in the power transmission region is avoided.

In an expedient refinement of the portable paint spraying system, the device for transmitting power is formed by electric contacts in the base station and corresponding mating contacts on the paint container, said contacts transmitting electric power to at least one heating device in the paint container.

Resistance heating elements which are integrated in the paint container are thereby formed by electric contact points, for example by contacts interengaging in an interlocking manner. By means of the electric contact connection, a current can flow through, for example, a heating element in the paint container and can transmit the generated heat to the quantity of paint to be heated.

In a further expedient refinement, the device for transmitting power is formed by an inductive and/or thermal coupling in the base station. The inductive and/or thermal power is then transmitted by the base station to an inductively and/or thermally operating heating device in the paint container such that the quantity of paint contained therein is heated. For example, metal plates or other types of heat store, which can be correspondingly coupled on, can be used for this purpose.

Inductive and/or thermal couplings to a device for transmitting power may be expedient in an individual case if, for example, paint containers made of non-conductive materials are present, or if locally different quantities of power are intended to be transmitted to the paint container.

In a development of the portable paint spraying system according to the invention, it is provided that the device for transmitting power and the paint container have means for producing an interlocking connection in at least one plane, wherein the means are preferably formed in the form of rotationally symmetrical or concentric and interengaging structures.

Corresponding means for producing an interlocking connection in a plane help to predetermine the position of the paint container in the region of the power transmission device, in which said paint container can be placed. This achieves an optimized and reproducible coupling of the paint container to the device for transmitting power. Furthermore, paint containers of this type are customarily designed as rotationally symmetrical bodies, for example as paint canisters or paint buckets, which, although they have to be positioned exactly with respect to the central axis thereof, can be arranged in a manner rotated as desired about the axis of symmetry thereof to the corresponding position on the device for transmitting power.

A further refinement according to the invention of the portable paint spraying system is characterized in that the paint container comprises a leadthrough for a drive shaft for a stirrer, wherein the drive shaft which is guided through the leadthrough preferably comprises, on one side, a star-shaped bushing for receiving an output shaft of a motor and, on another side, a star-shaped shaft section for receiving a stirring element, in particular a propeller.

By a stirring element being introduced into the quantity of paint to be heated, said quantity of paint can be moved during the heating, thus resulting in uniform heating. However, a problem frequently encountered in this case is the cleaning, since stirring elements of this type customarily have undercuts and inaccessible locations when said stirring elements are mounted fixedly in a paint container. The preferred refinement of the drive shaft for a stirrer with star couplings present on both sides affords the possibility both of separating the paint container from the base station and of dismantling the stirrer in the paint container and, for example, of removing the stirring element for cleaning purposes.

In a furthermore expedient refinement of the portable paint spraying system according to the invention, the paint container is fastenable to, preferably screwable on, the paint spraying means, wherein the paint is conveyed by a rising tube from the paint container to a spray nozzle on the paint spraying means.

One possibility of the spraying processing of the quantity of paint consists in screwing a paint container directly on a paint spraying means, for example a paint spray gun, such that the quantity of paint has to be moved during the processing with the paint spraying means. Care should be taken in this connection to ensure that the quantity of paint heated according to the invention and the paint container have a sufficient heat capacity so that, during the processing, i.e. while the paint container is not located on the device for transmitting power, the quantity of paint does not cool too greatly and therefore the desired processing temperature or the desired processing temperature range is departed from.

The paint container may also be heat insulated, for example, by means of a double-walled container or a suitable insulating layer on the container wall.

In a further expedient refinement of the portable paint spraying system according to the invention, it is provided that the paint container is formed on the surface of the base station or partially in the base station or completely in the base station, but preferably so as to be separable from the base station.

The base station may have a receiving space for a quantity of paint or may provide a receptacle for a paint container which is arranged partially in the base station or completely in the base station during the operation of processing the quantity of paint at the base station. In this case, the quantity of paint to be processed is conveyed via a paint conveying tube from the base station to the paint spraying means by means of a pump, wherein, in this case, the paint spraying means may advantageously be designed to be lightweight and compact, and therefore processing, in particular of relatively large quantities of paint, is possible without interruption, since paint does not have to be refilled into a container on the paint spraying means.

In this connection, the paint conveying tube may be heat insulated and/or the heating element may also be provided in or on the tube.

Furthermore, the invention comprises a method for processing quantities of paint to be sprayed, wherein, in an interchangeable paint container, a quantity of paint is heated to a temperature above an ambient temperature by a device for transmitting power. Furthermore, the heated quantity of paint is transported by a rising tube or by a paint tube to a paint spraying means, in particular to a paint spray gun, wherein, according to the invention, during the transmission of power to the paint container and the resultant heating of the quantity of paint, the latter is stirred by means of a stirrer.

The method according to the invention advantageously provides a quantity of paint for processing, in which the viscosity can be reduced to a sufficient extent in order to bring about an improved surface coating.

In a development of the method according to the invention, the quantity of paint is heated to a temperature of between 20° and 70°, preferably between 30° and 50° C.

In particular, it may be expedient for the user or apparatus manufacturer to predetermine two exact temperatures for processing two different paint categories, which temperatures may also be formed, for example, by the boundary ranges of the above-mentioned temperature ranges.

In a moreover expedient development of the method according to the invention, it is provided that the stirrer is operated at a rotational speed of 100 rpm to 300 rpm in an operating state during the transmission of power to a quantity of paint, and, preferably after the transmission of energy is ended, i.e. after the desired temperature for the quantity of paint is reached, still runs on for some time. In particular, the stirrer according to the method according to the invention may furthermore have a second operating state which serves for cleaning the paint container, and is operated at a rotational speed of 200 rpm to 500 rpm.

In order to circulate heated quantities of paint so that heating within the quantity of paint may be uniform, a low rotational speed generally suffices. However, it may be expedient for the stirrer still to run on even after the end of the heating of the quantity of paint, i.e., for example, after a desired processing temperature is reached, despite the device for transmitting heat energy being switched off, so that scorching or local overheating of the paint due to residual heat being present at the device for transmitting heat energy is avoided.

Expediently, a cleaning mode may also be provided according to the method according to the invention, said cleaning mode being characterized, for example, in a cleaning rotational speed, which is increased in relation to the heating rotational speed, at the stirrer. This considerably facilitates the cleaning of the paint container, since a manual movement of a cleaning fluid in the paint container is required only to a limited extent, if at all.

In a further development of the method according to the invention, the latter is characterized in that the device for transmitting power is controlled, in particular regulated, via temperature detection means in or on the paint container and/or via temperature detection means in the quantity of paint.

Temperature detection means may supply a control or regulating variable for the device for transmitting power from the temperature of the quantity of paint or the temperature of the paint container such that either the device for transmitting power can be controlled by the latter being switched on and off or the device for transmitting power is regulated in accordance with a predetermined parameter via a regulating device for regulating the power thereof.

In this manner, preferred heating curves or retaining parameters for determining a temperature to be maintained of a quantity of paint to be processed can be set.

A refinement according to the invention of a portable paint spraying system is illustrated in the exemplary embodiment below.

However, the invention is not restricted to the exemplary embodiment illustrated, but rather comprises all refinements which make use of the concept which is essential to the invention.

### BRIEF DESCRIPTION OF THE DRAWINGS

FIG. 1 shows a perspective illustration of a base station;

FIG. 2 shows an illustration of a base station according to the invention with a spray gun arranged thereon, illustrated without an air tube

FIG. 3 shows a schematic illustration of a portable paint spraying system according to the invention in section;

FIG. 4 shows a schematic illustration of a further portable paint spraying system according to the invention; and

FIG. 5 shows a schematic top view of the centering grooves of the device for transmitting power that is shown in FIG. 1.

### DETAILED DESCRIPTION OF THE INVENTION

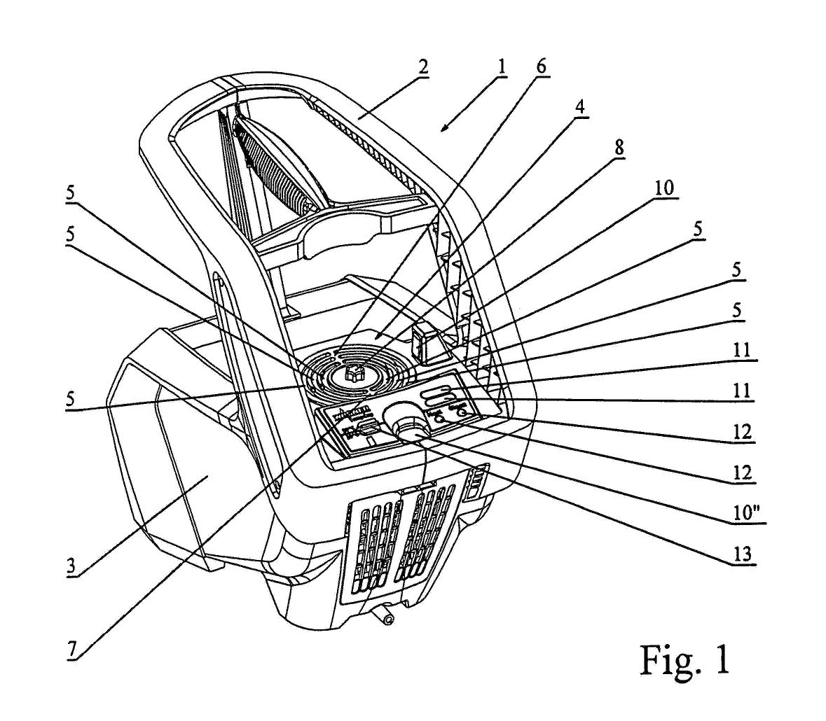

In detail, FIG. 1 shows a base station 1 of a portable paint spraying system according to the invention. The handle 2 of the base station 1 serves for handling and for transporting the base station 1 and is fastened to a housing 3 of the base station 1. The upper side of the base station 1 has a device 4 for transmitting power, said device being identified in the present illustration by means of centering grooves 5. On the inner sides thereof, the centering grooves 5 comprise contact regions in which said centering grooves can produce contact with a paint container arranged subsequently thereon and a heat generating device arranged in said paint container. After a half revolution, the centering grooves 5 have interruptions 6, 7 which form the two contact regions of the required polarity for an electric connecting line for a device for transmitting electric power. A star coupling 8 is located in the center of the arrangement of the centering grooves 5, said star coupling implementing a drive from the interior of the housing 3 of the base station 1 outward and, in a paint container according to the present invention with a stirrer integrated therein, being able to act on the stirrer.

The surface of the base station 1 furthermore has end switches 10, of which, in the present illustration, only the end switch 10 on the right-hand side can be seen. A correspondingly opposite end switch and an end switch in the handle region of the paint spray gun are provided. The end switch 10 serves to detect the presence of a paint container and accordingly only switches the device for transmitting power to an active state if a paint container which is to be heated is present.

The housing 3 of the base station 1 furthermore has operating elements 12 and displays 11 which describe the various operating states of the system according to the invention. Furthermore, a temperature selection switch 13 for a paint temperature of 30° C. or 50° C. is provided.

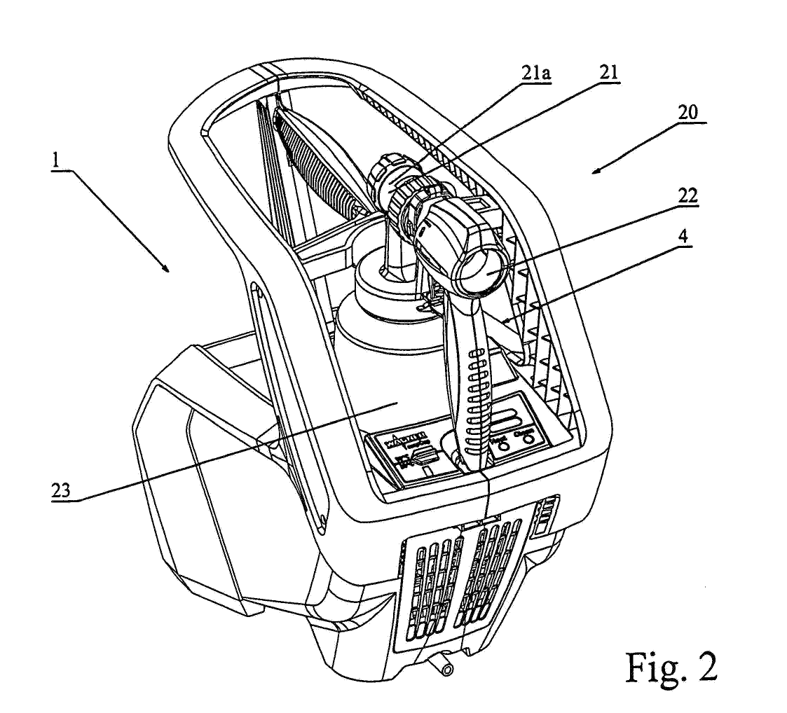

FIG. 2 shows a portable paint spraying system 20 according to the invention which comprises a base station 1 and a paint spraying means 21 designed as a paint spray gun 21. For the sake of clarity, the air tube which is normally fastened to the air connection 22 and which customarily connects the paint spray gun 21a to the base station 1 and to a blower contained therein is not illustrated.

The paint spray gun 21a comprises a paint container 23 which is screwed onto the paint spray gun 21a from below. The quantity of paint contained in the paint container 23 is heated during regular operation by the device for transmitting power 4 from the base station 1.

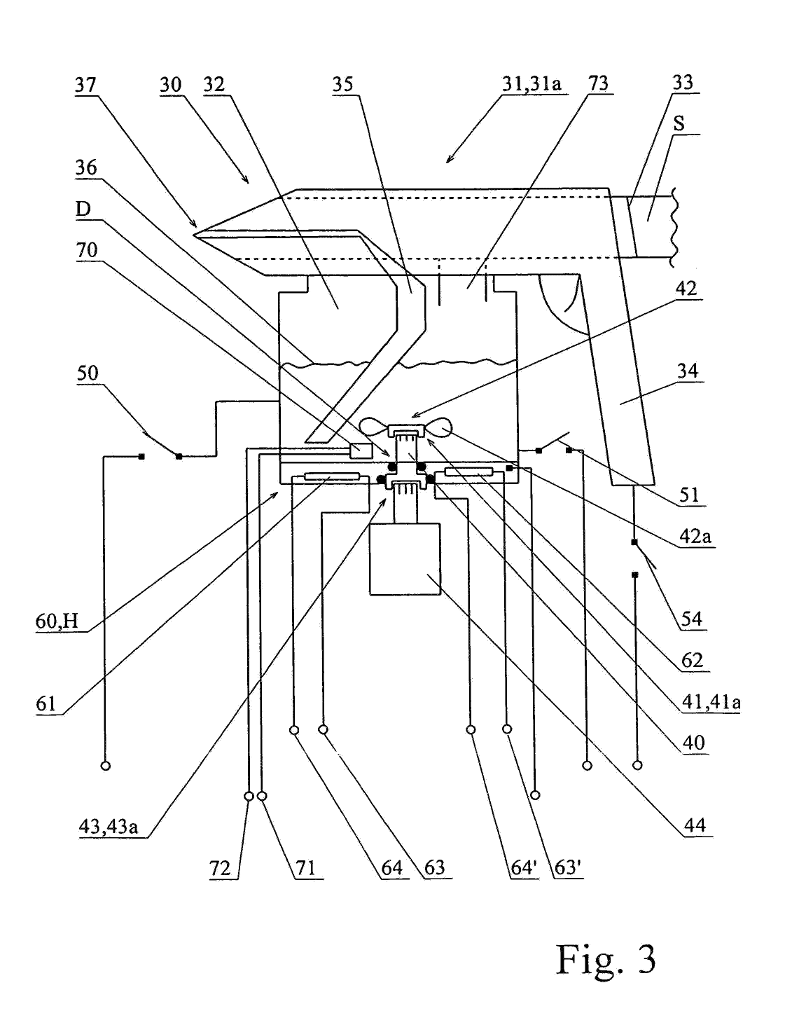

FIG. 3 shows a schematic illustration of a paint spraying system 30, wherein, in the present case, an illustration of the housing 3 of the base station 1 has been omitted in order clearly to illustrate the corresponding components enclosed internally.

In the case of the paint spraying system 30 according to the invention, a paint spray gun 31a, to the lower side of which a paint container 32 is fastened, is used as the paint spraying means 31. The spray gun has an air connection 33, by means of which the working air is conveyed by the blower out of the base station via a tube S. For handling purposes, the paint spray gun 31a has a handle 34 at which said paint spray gun is held in order to carry out painting work. A rising tube 35 is provided in the interior of the paint container 32, said rising tube connecting a quantity of paint 36 in the paint container 32 to a spray nozzle 37 such that the paint can be discharged from the spray nozzle 37. For clarity reasons, metering means, for example a needle valve, etc., are not illustrated.

The lower side of the paint container 32 according to the invention has a leadthrough D for a drive shaft 40 which has been led through a base of the paint container 32. The upper end of the drive shaft 40 has a coupling 41, which is designed as a star coupling 41a, for receiving a stirring element 42a of a stirrer 42. The stirring element 42a is easily separable from the shaft 40 for cleaning purposes by means of the star coupling 41a which is present. The lower side of the shaft 40 has a further coupling 43 which is designed as a star coupling 43 and via which the output shaft 44a of a motor/transmission unit 44 can act on the shaft 40 and therefore drives the stirring element 42a.

The end switches 10, 10′, 10″ release the conductor or the neutral conductor depending on the orientation by which the mains plugs have been plugged in.

A heating region 60 of the paint container 32 contains at least one resistance heater, in the present case two illustrated resistance heaters 61, 62, which are supplied with power by the device for transmitting power by the base station via corresponding heating contacts 63, 64. A heating device H therefore comprises at least one resistance heater 61 and/or 62. The heating contacts 63, 64 may be formed, for example, by the centering grooves 5 (illustrated in FIG. 1) via corresponding sliding contacts. Furthermore, the paint spraying system 30 according to the invention comprises a temperature sensor 70 which is connected to temperature sensor contacts 71, 72 and therefore permits control or regulation of the heating power of the corresponding resistance heater 61, 62 to the quantity of paint 36. In order to convey the paint into the rising tube 35, working air is fed to the paint container 32 via a compressed air duct 73 and is conducted via the tube S to the paint spray gun 31a.

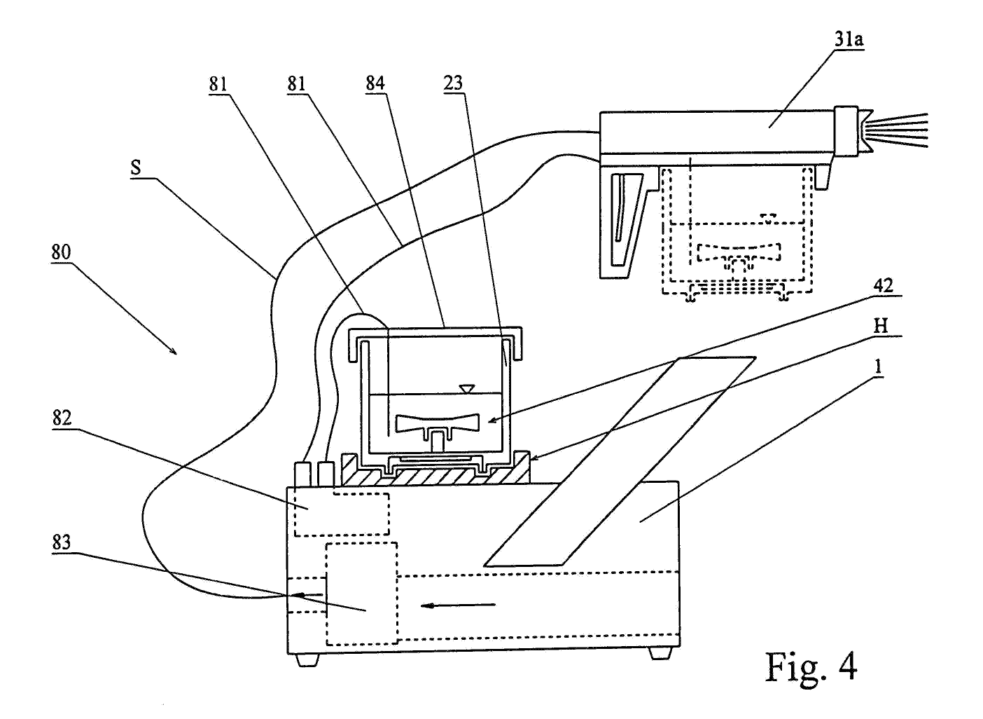

FIG. 4 shows a further paint spraying system 80 according to the invention in a schematic illustration. In the case of this paint spraying system, a paint container 23 remains on a base station 1 during the spraying of paint. The paint is conveyed out of the paint container 23 to a paint spray nozzle 31a by a paint tube 81, wherein the paint spraying system 80 comprises, for this purpose, a paint pump 82 which conveys the paint through the paint tube 81 to the paint spray gun 31a. A blower 83 by means of which air is conveyed through an air tube S to the paint spray gun 31a is furthermore illustrated in the base station 1 in FIG. 4. A stirrer 42 and a heating device H are furthermore illustrated schematically. It is shown by dashed lines how the paint container 23 can alternatively also be coupled directly to the paint spray gun 31a when the cover 84 is removed. In the case of such a coupling between the paint spray gun 31a and paint container 23, the paint tube 81 and the paint pump 82 can be omitted. The paint spray gun 31a is then connected to the base station 1 exclusively via the tube S.

In a further embodiment (not illustrated), it would also be conceivable to store the paint container in a depression of the housing 3 of the base station 1 and, for example, to pivot the stirrer from above into the paint container in order to omit the leadthrough of the shaft on the lower side. Furthermore, a termination by means of a cover on the top side of such a configuration would likewise be conceivable, thus producing a closed portable paint spraying system, in which a paint container does not need to be arranged on a spray gun, which considerably reduces the handleability and the weight to be moved during the processing of paint to be sprayed.

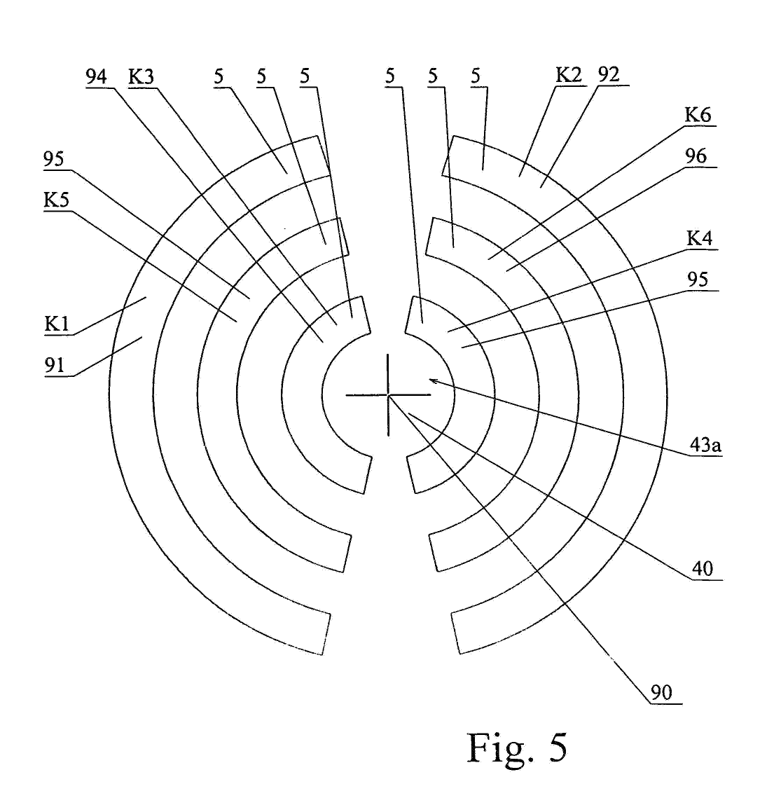

FIG. 5 finally shows a schematic top view of the centering grooves 5 of the device 4 for transmitting power (shown in FIG. 1). The six centering grooves 5 are arranged in the form of concentric circular arcs K1 to K6 with respect to an axis of rotation 90 of the star coupling 43a of the drive shaft 40. A neutral conductor 91, 92 is guided here in the two outer circular arcs K1 and K2. The two inner circular arcs K3 and K4 form the guide for a first ground conductor 93 and a second ground conductor 94. The first central circular arc K5 receives a first conductor 95, by means of which the heater power, which is required for a first heating power, can be supplied in the paint container (not illustrated). The second central circular arc K6 receives a second conductor 96, by means of which the heater power, which is required for a second heating power, can be supplied in the paint container (not illustrated).

### LIST OF DESIGNATIONS

1 Base station
2 Handle
3 Housing
4 Device for transmitting power
5 Centering grooves
6, 7 Interruptions in 5
8 Star coupling
10 End switch
10′ End switch
10″ End switch
11 Displays
12 Operating elements
13 Temperature selection switch
20 Paint spraying system
21 Paint spraying means
21a Paint spray gun
22 Air connection
23 Paint container
30 Paint spraying system
31 Paint spraying means
31a Paint spray gun
32 Paint container
33 Air connection
34 Handle
35 Rising tube
36 Quantity of paint
37 Spray nozzle
40 Drive shaft
41 Coupling on 40
41a Star coupling on 40
42 Stirrer
42a Stirring element
43 Coupling on 40
43a Star coupling on 40
44 Motor/transmission unit
44a Drive shaft of 44
50 Contact switch
51 Contact switch
54 Contact switch
60 Heating range
61 Resistance heater
62 Resistance heater
63, 63′ Heating contact
64, 64′ Heating contact
70 Temperature sensor
71, 72 Temperature sensor contact
73 Compressed air duct
80 Paint spraying system
81 Paint tube
82 Paint pump
83 Blower
84 Cover of 23
90 Axis of rotation of 40
91, 92 Neutral conductors
93, 94 Ground conductors
95, 96 Conductors
D Leadthrough
H Heating device
K1-K6 Circular arcs
S Tube

1. A portable paint spraying system, comprising
a base station with a blower;
paint spraying means;
at least one tube for connecting the base station and the paint spraying means;
at least one paint container for receiving a quantity of paint; and
a device for transmitting power to the paint container, wherein the quantity of paint in the paint container is heated by the transmitted energy, and the device for transmitting power is arranged in the base station.

2. The portable paint spraying system as claimed in claim 1, further comprising a stirrer submerged into the quantity of paint at least during the transmission of power to the paint container, and said quantity of paint is moved by the stirrer.

3. The portable paint spraying system as claimed in claim 1, wherein the device for transmitting power comprises electric contacts in the base station, said electric contacts transmitting electric power to at least one heating device in the paint container.

4. The portable paint spraying system as claimed in claim 1, wherein the device for transmitting power comprises at least one of an inductive and thermal coupling in the base station, which coupling transmits at least one of inductive and thermal power to at least one inductive heating device and/or at least one heat store.

5. The portable paint spraying system as claimed in claim 1, wherein the device for transmitting power and the paint container have means for producing an interlocking connection in at least one plane.

6. The portable paint spraying system as claimed in claim 1, wherein the paint container comprises a leadthrough for a drive shaft for a stirrer, wherein the drive shaft which is led through the leadthrough comprises, on one side, a coupling for receiving an output shaft of a motor, and, on another side, a coupling for receiving a stirring element.

7. The portable paint spraying system as claimed in claim 1, wherein the paint container is designed to be fastenable to the paint spraying means, wherein paint is conveyed by a rising tube from the paint container to a spray nozzle on the paint spraying means.

8. The portable paint spraying system as claimed in claim 1, wherein the paint container is formed on the surface of the base station, partially in the base station, or in the base station, and is separable from the base station.

9. A method for processing quantities of paint to be sprayed, wherein, in an interchangeable paint container, a quantity of paint is heated to a temperature above an ambient temperature by a device for transmitting power, and wherein the heated quantity of paint is transported by a rising tube or by a paint tube to a paint spraying means wherein, during the transmission of power to the paint container and the heating of the quantity of paint, the latter is stirred by a stirrer.

10. The method as claimed in claim 9, wherein the quantity of paint is heated to a temperature of between 20° C. and 70° C.

11. The method as claimed in claim 9, wherein the stirrer is operated at a rotational speed of 100 rpm to 300 rpm in an operating state during the transmission of power and, after the transmission of power is ended, still runs on for a time in a second operating state for cleaning purposes at a rotational speed of 200 rpm to 500 rpm.

12. The method as claimed in claim 9, wherein the device for transmitting power is regulated via temperature detection means in or on the paint container, in the quantity of paint, or in or on the paint container and in the quantity of paint.

13. A portable paint spraying system as claimed in claim 1, wherein the paint spraying means is a paint spray gun.

14. A portable paint spraying system as claimed in claim 1, wherein the heat store is a metal plate in the paint container, a metal plate on the paint container, or a metal plate in and on the paint container.

15. A portable paint spraying system as claimed in claim 1, wherein the interlocking connection is rotationally symmetrical or concentric and includes enter engaging structures.

16. A portable paint spraying system as claimed in claim 1, wherein the coupling on said one side of the drive shaft is in the form of a star coupling, and the coupling on said another side of the drive shaft is in the form of a star-shaped shaft section.

17. A portable paint spraying system as claimed in claim 1, wherein the stirring element is a propeller.

18. A portable paint spraying system as claimed in claim 1, wherein the paint container is fastenable to the paint spraying means by a threaded connection.

19. The method as claimed in claim 9, wherein the paint spraying means is a paint spray gun.

20. The method as claimed in claim 9, wherein the quantity of paint is heated to a temperature range of 30° C. and 50° C.
